(19) United States
(12) Patent Application Publication
(10) Pub. No.: US 2011/0316360 A1
(43) Pub. Date: Dec. 29, 2011

(54) LINEAR VIBRATORY DRIVE

(76) Inventor: Brian J. Rhinehart, Indianaplis, IN (US)

(21) Appl. No.: 13/168,233

(22) Filed: Jun. 24, 2011

Related U.S. Application Data
(60) Provisional application No. 61/358,259, filed on Jun. 24, 2010.

(51) Int. Cl. B65G 27/18; H02K 7/065; F16H 21/44; B65G 27/10; B65G 27/00

(52) U.S. Cl. 310/20; 74/96; 198/752.1; 198/761

(57) ABSTRACT

A system and apparatus are disclosed for a linear vibratory drive. In one embodiment, the drive includes a mounting bar coupled to a first flat leaf spring, the first flat leaf spring mounted on a stationary member, where the mounting bar is suitable for mounting a conveyance device such as a linear track or tray. A counterweight is coupled to a second flat leaf spring, where the second flat leaf spring is mounted on the stationary member, and where the counterweight is positioned such that a gap separates the counterweight from the mounting bar. A motor provides a vibrational pulse to the stationary member, thereby vibrating the mounting bar and the counterweight.

### RELATED APPLICATIONS

This application is related, and claims the benefit of U.S. Provisional Patent Application 61/358,259 entitled “INLINE DRIVE VIBRATORY PART FEEDER,” filed on Jun. 24, 2010, which is incorporated herein by reference in the entirety for all purposes.

### BACKGROUND

Unwanted machinery vibrations have plagued manufacturing facilities, especially near production lines where vibrations are often intentionally created, for example to aid in the propulsion or sorting of parts or conveyance of bulk materials. The transfer of these vibrations from a desired area to undesired areas may result in machinery failure and unwanted noise. Some current vibration reduction methods require significant up front expense or frequent maintenance. Therefore, further technological developments are desirable in this area.

### SUMMARY

One embodiment is a unique linear vibratory drive. Other embodiments include unique systems and apparatus to provide a linear vibratory drive with a reduction in undesirable transferred vibration. Further embodiments, forms, objects, features, advantages, aspects, and benefits shall become apparent from the following description and drawings.

### BRIEF DESCRIPTION OF THE DRAWINGS

FIG. 1 is a schematic perspective view of an linear vibratory drive.

FIG. 2 is an illustration of a full wave waveform and a half wave waveform.

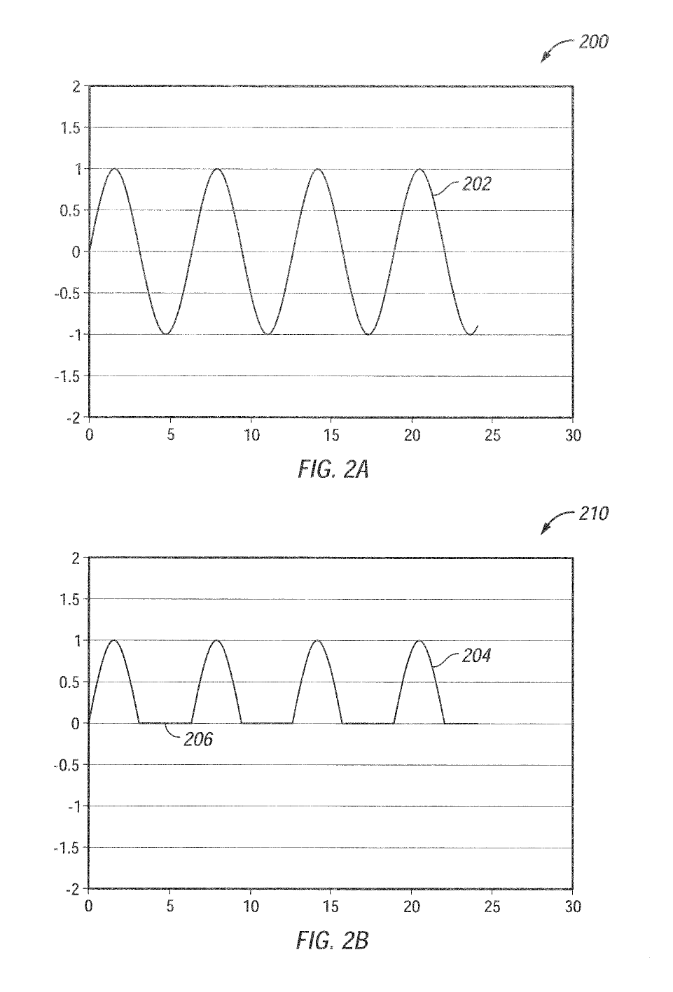

FIG. 3 is a schematic perspective view of another linear vibratory drive.

### DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

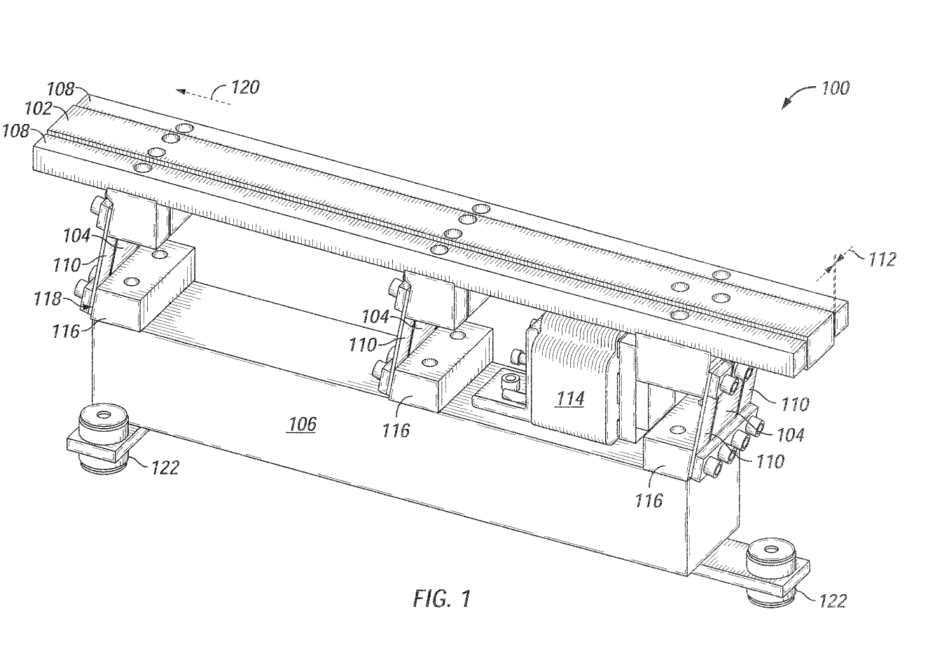

Referencing FIG. 1, an exemplary linear vibratory drive 100 includes a mounting bar 102 coupled to two or more flat leaf springs 104, where the leaf springs are mounted on a stationary member 106. The stationary member 106, as contemplated herein, is a member 106 that maintains a relative position to a mounting surface for the drive 100. The stationary member 106 moves on mounts sufficiently to transmit vibration between the motor 114, the mounting bar 102, and the counterweight(s) 108. In certain embodiments, the stationary member 106 is provided on mounts 122 that allow at least slight vertical movement of the stationary member 106. Exemplary mounts 122 include, without limitation, rubber, elastomeric materials, and coil springs. The drive 100 having the counterweights 108 and at least some of the other features described herein has a dramatically lower external vibrational profile delivered away from the feeder 100 system, including to a mounting table (not shown). Nevertheless, the use of semi-rigid rubber isolation mounts 122, or other vibration isolating devices, may be desirable in certain embodiments.

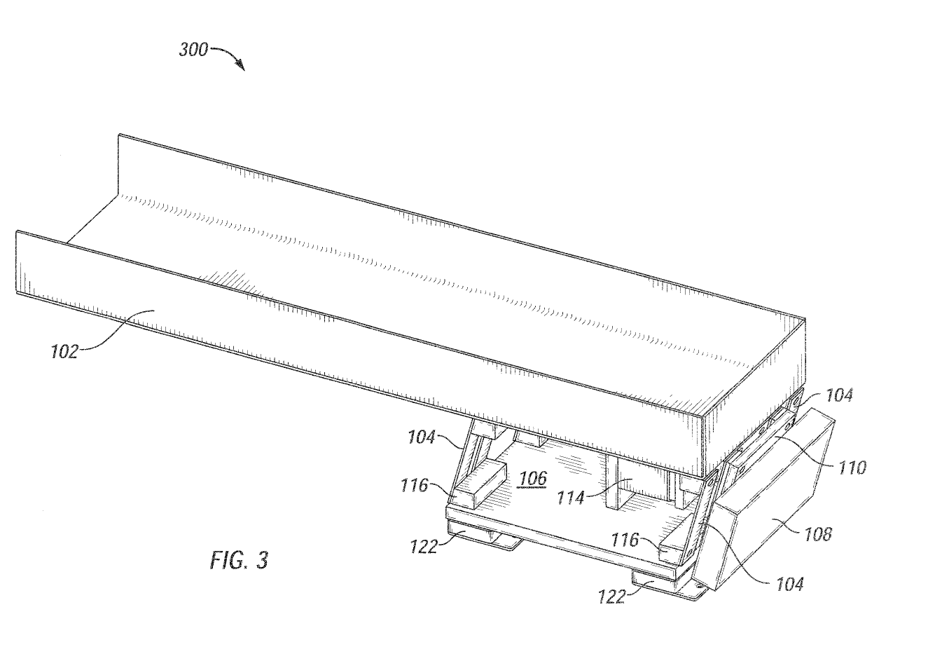

The linear vibratory drive 100 is illustrated to be suitable for mounting a parts tray, for example for providing parts to an ongoing assembly line process. However, the linear vibratory drive 100 may be utilized in any application and is not limited to the exemplary embodiments. The mounting bar 102 may additionally or alternatively include a tray, track, or other device suitable for a linear vibratory drive, for example as illustrated in FIG. 3.

An exemplary mounting bar 102 is suitable for mounting a linear track (not shown) such as a track for conveying small parts for an assembly process, a tray, or any other type of conveyance device amenable to a vibratory drive. An exemplary embodiment includes the mounting bar 102 protruding vertically above counterweight(s) 108 as shown. The track, where present, may be mounted at any position along the length of the mounting bar 102, and/or the track may be included as part of the mounting bar 102. The drive 100 further includes at least one counterweight 108 coupled to two or more flat leaf springs 110 that are a separate set of leaf springs 110 from the leaf springs 104 that are coupled to the mounting bar 102. The flat leaf springs 110, 104 may be leaf springs, flattened leaf springs, steel plates with a high degree of elasticity and/or any other suitable spring known to one of skill. The thickness and number of each set of springs 104, 110 is determined according to the vibrating weight of the drive 100 parts while in service, the frequency of the vibration of the drive 100, and can be determined and tuned as known to one of skill in the art. The counterweight(s) 108 are positioned such that a gap 112 separates the counterweights 108 from the mounting bar 102, preventing direct contact between the mounting bar 102 and the counter weights 108.

One of skill in the art, having the benefit of the disclosures herein, will appreciate that a close gap provides for a smaller overall size of the drive 100. However, a larger gap provides for more convenient manufacturing. An exemplary gap 112 is a ⅛″ gap, although gaps that are smaller or larger than ⅛″ are possible. The leaf springs 110 must be allowed to move independently of the leaf springs 104 at the upper end of the springs 104, the leaf springs 110 being attached to the counterweight 108, as shown. The leaf springs 110, 104 also include a gap therebetween, but the gap between the springs 110, 104 is not necessarily the same size as the gap 112, and in a specific embodiment is smaller.

The drive 100 further includes a motor 114 that provides a vibrational pulse to the mounting bar 102. In some embodiments, the motor 114 is a full-wave drive motor, and in certain further embodiments the motor 114 operates at a frequency above 60 Hz, at 100 Hz, at 120 Hz, at 15 Hz, at 300 Hz, and at a frequency between 15 Hz and 300 Hz. The motor 114 operating at higher or lower frequencies, as well as a motor 114 having a variable frequency controller, are also contemplated herein. In certain embodiments, the motor 114 is a full-wave drive motor without a frequency controller. The motor 114 may be any device capable of providing a consistent, intermittent pulse as is known to one of skill in the art. The mounting bar 102 may be connected to an armature plate that is connected via the springs to the motor 114, thus transferring vibration energy from the motor 114 to the mounting bar 102. The mechanism to transfer vibrational energy from the motor 114 to the mounting bar 102 may be any mechanism understood in the art.

In certain embodiments, the leaf springs 104, 110 for the mounting bar 102 and the counterweights 108 are mounted at an offset angle from a perpendicular angle relative to the stationary member 106, or relative to a level horizontal angle. In certain embodiments, the offset angle is a deviation of the leaf springs 104, 110 from a vertical orientation. The offset angle may be any angle that allows movement of the parts in a tray (not shown) mounted to the mounting bar 102 in response to vibrations of the motor 114. It is a mechanical step for one of skill in the art to determine an appropriate angle according to a specific contemplated embodiment, but exemplary angles of 5° to 30° of offset are understood to function well in many applications.

An exemplary embodiment includes the leaf springs 104, 110 mounted to a number of stationary mounting members 116, each stationary mounting member 116 having a side beveled 118 at the offset angle. The leaf springs are mounted on the stationary mounting members 116 at the side beveled 118 at the offset angle, providing the offset angle to the mounted leaf spring 104, 110. The leaf springs 104, 110 are illustrated with a single clamp at the bottom of the springs 104, 110 and fasteners through the clamp fixing the springs 104, 110 to the stationary mounting member 116. The leaf springs 104, 110 may be fixed individually to the stationary mounting member 116 and/or to the stationary member 106. The exemplary drive 100 includes the offset angle pointing away from the part movement direction 120 of parts in the mounted linear track (not shown).

In an exemplary drive 100, the center of mass of the mounting bar(s) 102 and the center of mass of the counter weight(s) 108 are positioned on a vertical axial plane bisecting the drive 100. In a further example, the axial differential center of mass of the mounting bar(s) 102 and the center of mass of the counter weight(s) 108 line up along the vertical axial plane bisecting the drive 100. The center of mass, as described herein, references the center of mass of the sum of the mounting bar(s) 102 and counterweight(s) 108 for embodiments where more than one mounting bar 102 and/or counterweight 108 are provided. For example, at a given axial position, the axial differential center of mass of the counter weight(s) 108 is the averaged center of mass of a differential slice of the counter weight(s) 108 at the given axial position. In another embodiment, the axial center of mass of the mounting bar 102 aligns with the axial center of mass of the counter weights 108, but not necessarily with the vertical axial plane bisecting the drive 100.

The exemplary drive 100 further includes the center of mass of the counterweight(s) 108 falling on a horizontal plane bisecting the mounting bar 102. In a further embodiment, the axial differential center of mass of the counterweight(s) 108 aligns horizontally with the axial differential center of mass of the mounting bar(s) 102 along the length of the drive 100 on the horizontal plane. For example, the drive 100 includes counterweights 108 that have a center of mass along the same horizontal plane as the mounting bar 102 along the length of the drive 100. In certain embodiments, the counterweights 108 have a center of mass along a parallel horizontal plane as the mounting bar 102 along the length of the drive 100.

Another exemplary drive 100 includes the counterweight(s) 108 having a variable differential mass with respect to linear distance along the counterweight 108. For example, the cross-sectional shape of the counterweight 108 may be varied along the linear distance to change the differential mass with respect to linear distance, the material used in the counterweight 108 may be varied along the length of the counterweight 108, notches, drilled holes, or other material removal features may be included at desired positions along the counterweight 108, and/or auxiliary weights may be attached to the counterweight 108 at desired positions along the counterweight 108. Areas where the differential mass of the counter weight is increased will experience a slower conveyance along the drive 100, while areas having a decreased differential mass of the counter weight will experience a faster conveyance along the drive 100. Therefore, one of skill in the art having the benefit of the disclosures herein, can configure the counterweights 108 to provide a variable conveyance speed along the drive 100 as a function of the linear position along the drive 100.

An exemplary configuration includes a drive 100 having a slower entry portion of the drive 100 on the feed end, and a faster exit portion of the drive 100 at the exit end. Another exemplary configuration includes the drive 100 having a faster entry portion of the drive 100 on the feed end, and a slower exit portion of the drive 100 at the exit end. The variation of the differential mass along the linear distance may be continuous, discrete, or according to any function understood in the art and as provided by the features utilized to implement the differential mass.

Yet another exemplary drive 100 includes a single mounting bar 102 centered above the stationary member 106, and two counterweights 108 positioned with one on each side of the single mounting bar 102. The illustrated drive 100 in FIG. 1 is configured with the single mounting bar 102 and the two counterweights 108 positioned on each side. An exemplary drive 100 further includes a counterweight synchronizer (not shown) that vibrationally couples a first of the two counterweights 108 to a second of the two counterweights 108. The counterweight synchronizer may be any vibrational coupling device understood in the art, including at least a cross-member, an L-bracket, or any other rigid device affixed to both counterweights 108 such that the counterweights 108 will move together.

The exemplary drive 100 further includes the two counterweights 108 having a size and position such that the counterweights 108 do not extend axially past the single mounting bar 102 at an exit end of the drive 100. The exemplary drive 100 includes the motor 114 being a full-wave drive motor, for example an un-rectified AC motor.

In the art, linear drives are known to have issues with a full-wave drive motor at high frequencies, including part “walking” within the tray and not staying on a single side. Accordingly, a rectified motor, illustrated at curve 210 includes vibration portions 204 and rectified portions 206 effectively cutting the pulse frequency in half may be utilized. A drive 100 including counterweights 108, the mounting bar 102, and springs 110, 104 allows the use of a full-wave drive motor, illustrated at 200 with the curve 202, in certain circumstances where a rectified or controlled frequency motor would otherwise be required.

Still another exemplary drive (not shown) includes a single counterweight positioned above the stationary member, and two mounting bars positioned with one on each side of the single counterweight. In the exemplary drive having a single counterweight, the conveyance device is mounted to the mounting bars. The exemplary drive having two mounting bars further includes, in certain embodiments, a mounting bar synchronizer that vibrationally couples a first of the two mounting bars to a second of the two mounting bars.

Another exemplary drive 300 is illustrated in FIG. 3. The drive 300 includes a mounting bar 102 comprising a tray. The mounting bar 102 is coupled to leaf springs 110 and vibrationally coupled to a motor 114 through the stationary member 106. The drive 300 includes a counterweight 108 coupled to a leaf spring 104 and vibrationally coupled to the motor 114 through the stationary member 106. The drive 300 further includes mounts 122 suitable to couple the stationary member 106 to a mounting surface (not shown). The springs 104, 110 are structured to allow the counterweight 108 and the mounting bar 102 to vibrate independently.

An exemplary procedure for using a linear vibratory drive is described. The exemplary procedure illustrates certain operations that are understood to be exemplary only, and operations may be combined or divided, and added or removed, as well as re-ordered in whole or part, unless stated explicitly to the contrary herein. Certain operations may be implemented by a computer executing a computer program product on a computer readable medium, where the computer program product comprises instructions causing the computer to execute one or more of the operations, or to issue commands to other devices to execute one or more of the operations.

The exemplary procedure includes an operation to provide a linear vibratory drive. The provided drive includes one or more mounting bars coupled to a one or more flat leaf springs, and one or more counterweights mounted to one or more flat leaf springs, where all of the leaf springs are mounted on a stationary member. The mounting bar is suitable for mounting a linear track, tray, or conveyance device. The counterweight(s) are positioned such that a gap separates the counterweight(s) from the mounting bar(s). In certain embodiments, the counterweights have a variable differential mass with respect to linear distance along the counterweight. The drive further includes a motor that provides a vibrational pulse to the mounting bar and the counterweights through the stationary member.

The procedure further includes an operation to provide a conveyance material to the drive, and an operation to vibrate the drive with the motor, where the motor is a full-wave drive. In certain embodiments, the operation to vibrate the drive includes vibrating the drive at a frequency greater than 60 Hz, at 100 Hz, or at 120 Hz. Alternatively or additionally, the operation to vibrate the drive includes vibrating the drive at a frequency of 15 Hz, a frequency of 300 Hz, and/or a frequency between 15 Hz and 300 Hz. The conveyance material includes assembly parts, fasteners, bulk material, and/or any other conveyance material understood in the art. The procedure further includes, in response to the vibrating, moving the conveyance material linearly across the drive. The linear movement across the parts drive includes moving the part with a variable speed as a function of the linear position along the drive.

As is evident from the figures and text presented above, a variety of embodiments according to the present invention are contemplated.

An exemplary set of embodiments is a linear vibratory drive including a mounting bar coupled to a first flat leaf spring, the first flat leaf spring mounted on a stationary member, where the mounting bar is suitable for mounting a conveyance device. The drive may be positioned where the mounting bar is above or below the stationary member. The conveyance device may include a linear track, tray, or other conveyance device. The conveyance device may be mounted on the mounting bar, and/or included as a portion of the mounting bar. The drive further includes one or more counterweights coupled to a second flat leaf spring, the second flat leaf spring mounted on the stationary member, and where the at least one counterweight is positioned such that a gap separates each of the counterweight from the mounting bar. As with the mounting bar, the drive may be positioned such that the counterweight is positioned above or below the stationary member.

The drive includes any desired number of first leaf springs and second leaf springs to support the mounting bar(s) and counterweights(s). The drive further includes a motor that provides a vibrational pulse to the mounting bar, for example by providing vibrational pulses to the stationary member.

An exemplary drive includes each of the first leaf spring and the second leaf spring are mounted at an offset angle from a perpendicular angle relative to the stationary member. In certain embodiments, the offset angle includes a value between 5 degrees and 30 degrees. In certain further embodiments, the drive includes a number of stationary mounting members each having a side beveled at the offset angle, and the first leaf spring and the second leaf spring are each mounted on one of the stationary mounting members at the side beveled at the offset angle. An exemplary drive includes the offset angle pointing away from the part movement direction of a mounted linear track.

An exemplary drive includes a first center of mass of the mounting bar positioned at a vertical axial plane bisecting the drive, and a second center of mass of the at least one counterweight is positioned at least one of a vertical axial plane bisecting the drive and a horizontal plane bisecting the mounting bar. Another exemplary drive includes the mounting bar protrudes vertically above the at least one counterweight.

In certain embodiments, the counterweight includes a variable differential mass with respect to linear distance along the counterweight. An exemplary drive includes the variable differential mass having an increased differential mass at a feed end of the drive and a reduced differential mass at a discharge end of the drive. Another exemplary drive includes a single mounting bar centered above the stationary member, and two counterweights positioned with one on each side of the single mounting bar. In certain further embodiments, the drive includes a counterweight synchronizer that vibrationally couples a first of the two counterweights to a second of the two counterweights. An exemplary drive includes a single counterweight positioned at a feed end of the drive.

Another exemplary drive includes a single counterweight positioned above the stationary member and a second mounting bar, the two mounting bars positioned with one on each side of the single counterweight. A further exemplary embodiment includes a mounting bar synchronizer that vibrationally couples the first of the two mounting bars to the second of the two mounting bars.

Yet another exemplary set of embodiments is a linear vibratory drive apparatus, including at least one mounting bar coupled to a first flat leaf spring, the first flat leaf spring mounted on a stationary member, and the mounting bar suitable for mounting a conveyance device. The exemplary apparatus includes at least one counterweight coupled to a second flat leaf spring, the second flat leaf spring mounted on the stationary member, where the at least one counterweight is positioned such that a gap separates the at least one counterweight from the at least one mounting bar. The apparatus further includes each of the first flat leaf spring and the second flat leaf spring mounted at an offset angle from a perpendicular angle relative to the stationary member, and a motor structured to provide vibration to the mounting bar.

In certain further embodiments, the motor is a full-wave drive motor. An exemplary motor operates at a frequency including 120 Hz, 100 Hz, and/or at a greater frequency than 60 Hz.

An exemplary apparatus includes a number of stationary mounting members having a side beveled at the offset angle, where each of the first leaf spring and the second leaf spring is mounted on one of the stationary mounting members at the side beveled at the offset angle. The exemplary apparatus further includes the mounting bar(s) protruding vertically above the counterweight(s), where the counterweight(s) include a variable differential mass with respect to linear distance along the counterweight.

Another exemplary apparatus includes a single mounting bar centered above the stationary member, two counterweights positioned with one on each side of the single mounting bar, and a counterweight synchronizer that vibrationally couples a first of the two counterweights to a second of the two counterweights. The apparatus includes the two counterweights positioned such that they do not extend axially past the single mounting bar at the discharge end of the drive.

Yet another exemplary apparatus includes a single counterweight positioned above the stationary member, two mounting bars positioned with one on each side of the single counterweight, and a mounting bar synchronizer that vibrationally couples a first of the two mounting bars to a second of the two mounting bars. In a further embodiment, the apparatus includes a mounting bar synchronizer that vibrationally couples a first of the two mounting bars to a second of the two mounting bars.

Still another exemplary set of embodiments is a linear vibratory drive system including a means for moveably coupling a mounting bar to a stationary member, where the mounting bar is structured to vibrate, and where the mounting bar is suitable for receiving a conveyance device. The system further includes a means for moveably coupling a counterweight to the stationary member, where the counterweight is structured to vibrate. The system further includes a means for providing vibration to the stationary member. An exemplary system further includes a linear track coupled to the mounting bar and means for moving a number of parts linearly across the linear track. The system further includes a means for varying a speed of the movement of the plurality of parts across the linear track.

While the invention has been illustrated and described in detail in the drawings and foregoing description, the same is to be considered as illustrative and not restrictive in character, it being understood that only certain exemplary embodiments have been shown and described and that all changes and modifications that come within the spirit of the inventions are desired to be protected. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A linear vibratory drive, comprising:
a mounting bar coupled to a first flat leaf spring, the first flat leaf spring mounted on a stationary member, the mounting bar suitable for mounting a conveyance device;
at least one counterweight coupled to a second flat leaf spring, the second flat leaf spring mounted on the stationary member, wherein the at least one counterweight is positioned such that a gap separates each of the at least one counterweight from the mounting bar; and
a motor structured to provide a vibrational pulse to the mounting bar.

2. The drive of claim 1, wherein each of the first leaf spring and the second leaf spring are mounted at an offset angle from a perpendicular angle relative to the stationary member.

3. The drive of claim 2, wherein the offset angle comprises a value between 5 degrees and 30 degrees.

4. The drive of claim 3, further comprising a plurality of stationary mounting members having a side beveled at the offset angle, and wherein the first leaf spring and the second leaf spring are each mounted on one of the stationary mounting members at the side beveled at the offset angle.

5. The drive of claim 3, wherein the offset angle points away from the part movement direction of a mounted linear track.

6. The drive of claim 1, wherein a first center of mass of the mounting bar is positioned at a vertical axial plane bisecting the drive and a second center of mass of the at least one counterweight is positioned at least one of a vertical axial plane bisecting the drive and a horizontal plane bisecting the mounting bar.

7. The drive of claim 1, wherein the mounting bar protrudes vertically above the at least one counterweight.

8. The drive of claim 1, wherein the at least one counterweight comprises a variable differential mass with respect to linear distance along the counterweight.

9. The drive of claim 8, wherein the variable differential mass comprises an increased differential mass at a feed end of the drive and a reduced differential mass at a discharge end of the drive.

10. The drive of claim 1, further comprising a single mounting bar centered above the stationary member, and two counterweights positioned with one on each side of the single mounting bar.

11. The drive of claim 10, further comprising a counterweight synchronizer that vibrationally couples a first of the two counterweights to a second of the two counterweights.

12. The drive of claim 10, further comprising a single counterweight positioned at a feed end of the drive.

13. The drive of claim 1, further comprising a single counterweight positioned above the stationary member and a second mounting bar, the two mounting bars positioned with one on each side of the single counterweight.

14. The drive of claim 13, further comprising a mounting bar synchronizer that vibrationally couples the first of the two mounting bars to the second of the two mounting bars.

15. A linear vibratory drive apparatus, comprising:
at least one mounting bar coupled to a first flat leaf spring, the first flat leaf spring mounted on a stationary member, the mounting bar suitable for mounting a conveyance device;
at least one counterweight coupled to a second flat leaf spring, the second flat leaf spring mounted on the stationary member, wherein the at least one counterweight is positioned such that a gap separates the at least one counterweight from the at least one mounting bar;
wherein each of the first flat leaf spring and the second flat leaf spring is mounted at an offset angle from a perpendicular angle relative to the stationary member; and
a motor structured to provide vibration to the mounting bar.

16. The apparatus of claim 15, wherein the motor is a full-wave drive motor.

17. The apparatus of claim 16, wherein the motor operates at a frequency selected from the frequencies consisting of: 15 Hz, 120 Hz, 100 Hz, 300 Hz, a range between 15 Hz and 300 Hz, and greater than 60 Hz.

18. The apparatus of claim 15, wherein the stationary member comprises semi-rigid rubber isolation mounts.

19. The apparatus of claim 15, further comprising a plurality of stationary mounting members having a side beveled at the offset angle;
wherein each of the first leaf spring and the second leaf spring is mounted on one of the stationary mounting members at the side beveled at the offset angle; and
wherein the at least one mounting bar protrudes vertically above the at least one counterweight and wherein the at least one counterweight comprises a variable differential mass with respect to linear distance along the counterweight.

20. The apparatus of claim 19, further comprising:
a single mounting bar centered above the stationary member;
two counterweights positioned with one on each side of the single mounting bar;
a counterweight synchronizer that vibrationally couples a first of the two counterweights to a second of the two counterweights; and
wherein the two counterweights do not extend axially past the single mounting bar at a discharge end of the drive.

21. The apparatus of claim 19, further comprising:
a single counterweight positioned above the stationary member;
two mounting bars positioned with one on each side of the single counterweight; and
a mounting bar synchronizer that vibrationally couples a first of the two mounting bars to a second of the two mounting bars.

22. The apparatus of claim 21, further comprising a mounting bar synchronizer that vibrationally couples a first of the two mounting bars to a second of the two mounting bars.

23. A linear vibratory drive system, comprising:
means for moveably coupling a mounting bar to a stationary member, the mounting bar structured to vibrate;
wherein the mounting bar is suitable for receiving a conveyance device;
means for moveably coupling a counterweight to the stationary member, the counterweight structured to vibrate; and
means for providing vibration to the stationary member.

24. The system of claim 23, further comprising a linear track coupled to the mounting bar and means for moving a plurality of parts linearly across the linear track.

25. The system of claim 24, further comprising means for varying a speed of the movement of the plurality of parts across the linear track.
